(19) United States
(12) Patent Application Publication
(10) Pub. No.: US 2006/0197257 A1
(43) Pub. Date: Sep. 7, 2006

(54) SIMULATED STONE, BRICK, AND MASONRY PANELS AND WALL STRUCTURES

(76) Inventors: Kevin T. Burt, Columbus, OH (US); Moe Nasr, Houston, TX (US); Kurt Kuriger, Willis, TX (US)

Correspondence Address: STANDLEY LAW GROUP LLP, 495 METRO PLACE SOUTH, SUITE 210, DUBLIN, OH, 43017, US

(21) Appl. No.: 11/278,537

(22) Filed: Apr. 3, 2006

Related U.S. Application Data
(63) Continuation-in-part of application No. 10/971,861, filed on Oct. 22, 2004.
(60) Provisional application No. 60/667,633, filed on Apr. 1, 2005.
(60) Provisional application No. 60/514,414, filed on Oct. 24, 2003.

(51) Int. Cl. B29C 41/22

(52) U.S. Cl. 264/255; 264/310

(57) ABSTRACT

Products and methods that may enhance the manufacturing, structure, appearance, assembly, or installation of synthetic building or construction products. In particular, exemplary embodiments include panels, wall structures, and other panel assemblies that may have contoured or textured surfaces to simulate the appearances of other building or construction products. For instance, exemplary embodiments of panels, wall structures, and other panel assemblies may have contoured and textured surfaces that may simulate the appearances of conventional building or construction materials including, but not limited to, stone, bricks, masonry, concrete, stucco, wood, other conventional building materials, and combinations of any of these materials.

This application claims the benefit of U.S. Provisional Application No. 60/667,633, filed Apr. 1, 2005, which is hereby incorporated by reference in its entirety. This application is also a continuation-in-part of U.S. application Ser. No. 10/971,861, filed Oct. 22, 2004, which claims the benefit of U.S. Provisional Application No. 60/514,414, filed Oct. 24, 2003, each of which is also hereby incorporated by reference in its entirety.

### BACKGROUND AND SUMMARY OF THE INVENTION

The present invention relates generally to panels and wall structures and related methods of manufacture. More particularly, exemplary embodiments of the present invention relate to synthetic panels and wall structures that simulate the appearance of other building products. For instance, exemplary embodiments of the panels and wall structures of the present invention may simulate conventional building or construction materials such as panels and wall structures made from materials including, but not limited to, stone, brick, masonry, stucco, concrete, wood, other conventional building and construction materials, and combinations thereof.

Other simulated building products possess many drawbacks that limit their effectiveness. For example, other simulated stone panels commonly align the edges of the synthetic stones in a substantially straight line along each edge of the panels. As a result, when the panels are interconnected together, there are obvious straight lines that extend across the wall structure where the panels are joined together. Thus, no matter how realistic each individual panel may look, the overall wall structure looks synthetic because it is obvious where the panels have been joined together. In addition, other simulated building products lack an adequate transition to another type of building material. For example, other simulated stone panels lack an adequate transition to other building materials such as siding or stucco.

Exemplary embodiments of the present invention include products and methods that may enhance the manufacturing, structure, appearance, assembly, or installation of synthetic building or construction products. In particular, exemplary embodiments include panels, wall structures, and other panel assemblies that may have contoured or textured surfaces to simulate the appearances of other building or construction products. For instance, exemplary embodiments of panels, wall structures, and other panel assemblies may have contoured and textured surfaces that may simulate the appearances of conventional building or construction materials including, but not limited to, stone, bricks, masonry, concrete, stucco, wood, other conventional building materials, and combinations of any of these materials.

Exemplary embodiments of the present invention may be selected to suit a desired application. For instance, some exemplary embodiments of the present invention include panels that may have an improved configuration for obscuring the joint between adjacent panels when installed. Some exemplary embodiments of the present invention also include components for improving the transition to another building or construction material. Furthermore, some exemplary embodiments of the present invention include an improved method of installing a synthetic wall structure or panel assembly that helps to obscure the joint between adjacent panels. In addition, some exemplary embodiments of the present invention include improved methods for manufacturing panels and wall structures that are adapted to simulate other building or construction materials.

In addition to the novel features and advantages mentioned above, other features and advantages of the present invention will be readily apparent from the following descriptions of the drawings and exemplary embodiments.

### BRIEF DESCRIPTION OF THE DRAWINGS

FIG. 1 is a side elevation view of an exemplary embodiment of a starter panel of the present invention.

FIG. 2 is a side elevation view of a first exemplary embodiment of a field panel of the present invention.

FIG. 3 is a view of an edge of the field panel of FIG. 2.

FIG. 4 is a side elevation view of a second exemplary embodiment of a field panel of the present invention.

FIG. 5 is a view of an edge of the field panel of FIG. 4.

FIG. 6 is a first side elevation view of an exemplary embodiment of a corner panel of the present invention.

FIG. 7 is a first view of an edge of the corner panel of FIG. 6.

FIG. 8 is a second side elevation view of the corner panel of FIG. 6.

FIG. 9 is a second view of an edge of the corner panel of FIG. 6.

FIG. 10 is a perspective view of an exemplary embodiment of a wall structure of the present invention that comprises a corner panel and a starter panel.

FIG. 11 is a perspective view of an exemplary embodiment of a wall structure of the present invention that shows how corner panels may be stacked.

FIG. 12 is a perspective view of an exemplary embodiment of a wall structure of the present invention that shows how starter panels may be connected.

FIG. 13 is a perspective view of an exemplary embodiment of a wall structure of the present invention that shows how a field panel may be connected with a corner panel and a starter panel.

FIG. 14 is a perspective view of an exemplary embodiment of a wall structure of the present invention that utilizes a cap cup (a detailed view of this exemplary embodiment of a cap cup is also provided).

FIG. 15 is a perspective view of an exemplary embodiment of a wall structure of the present invention that shows how a cap trim block may be positioned on a cap cup.

FIG. 16 is a perspective view of an exemplary embodiment of a wall structure of the present invention that shows how a cap trim block may be used as a transition between a wall structure and another building material.

FIG. 17 is a side elevation view of another exemplary embodiment of a panel of the present invention.

FIG. 18 is a side elevation view of an exemplary embodiment of a wall structure of the present invention that uses the panel of FIG. 17.

FIG. 19 is an exploded, perspective view of another exemplary embodiment of a wall structure of the present invention.

### DETAILED DESCRIPTION OF EXEMPLARY EMBODIMENT(S)

The present invention is directed to products and methods that may enhance the manufacturing, structure, appearance, assembly, or installation of synthetic building or construction products. Exemplary embodiments of the present invention include panels that may have contoured or textured surfaces adapted to simulate the appearances of other building products. For instance, exemplary embodiments of panels of the present invention may have contoured and textured surfaces that may simulate the appearances of conventional building or construction materials including, but not limited to, stone, bricks, masonry, concrete, stucco, wood, other conventional building materials, and combinations of any of these materials.

Exemplary embodiments of the present invention may be used for various applications. For instance, exemplary embodiments of panels include, but are not limited to, wall panels, fence panels, siding panels, and other suitable types of panels. As a result, exemplary embodiments of panels of the present invention may be used to make various types of barriers or structures such as walls, fences, siding assemblies, other types of panel assemblies, and any other suitable types of barriers or structures.

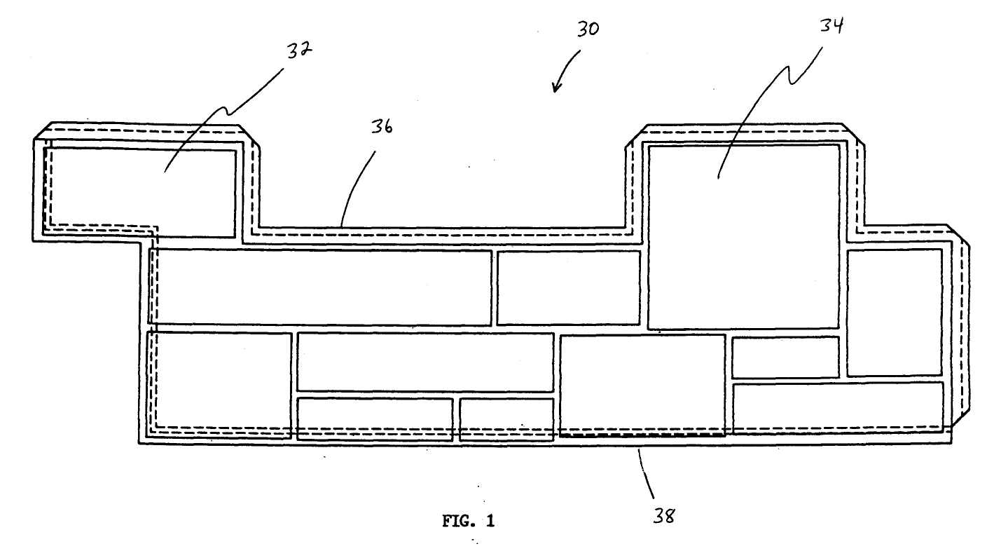

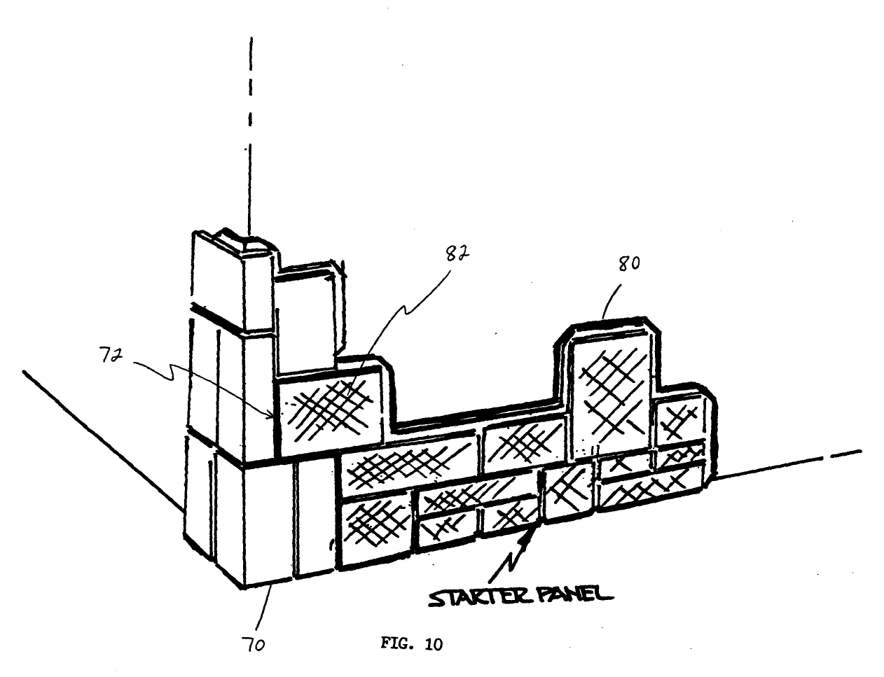

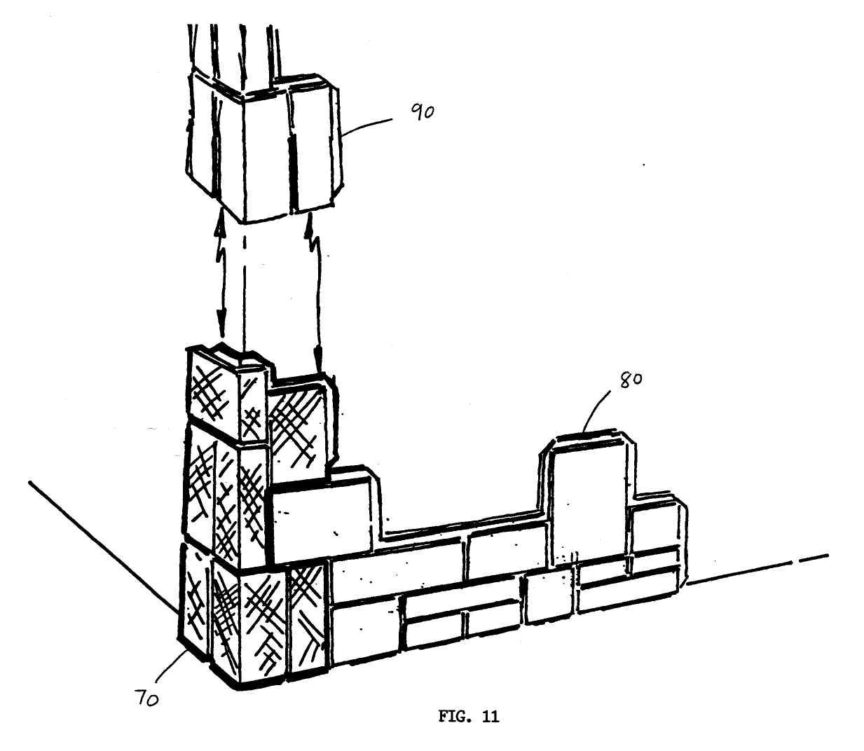

FIGS. 1 through 9 are examples of panels that may simulate the appearance of masonry. In these examples, the panels are adapted to simulate the appearance of masonry that is comprised of stones (such panels may also be referred to as simulated stone panels). In some other exemplary embodiments, panels may be adapted to simulate the appearance of masonry that may be comprised of any additional or alternative substrate including, but not limited to, bricks and any other substrate material that is suitable for masonry. Referring to FIGS. 1 through 9, each of the panels has at least one edge in which the synthetic stones are not evenly aligned. In other words, the synthetic stones do not form a straight line along at least one edge of the panel. Instead, at least one stone juts out relative to the other stone(s) along at least one edge of the panel. For example, referring to FIG. 1, panel 30 is comprised of a simulated stone 32 and a simulated stone 34 that jut out relative to the other stones along a top edge 36 of panel 30. In this example, simulated stones also jut out relative to the right and left side edges of panel 30. It should be recognized that stones may jut out in other suitable manners. For example, a jutting relationship may also be accomplished by providing at least one stone with a configuration such that a portion juts out (e.g., a L-shaped or T-shaped stone). Of course, it should be recognized that the same type of effect may be achieved with other exemplary embodiments of the present invention that simulate other building or construction materials (e.g., brick).

More particularly, FIG. 1 shows an example of a starter panel 30. The starter panel has a substantially straight bottom edge 38. For example, substantially straight bottom edge 38 may be useful if the panel is situated adjacent to the ground or in other installations in which a straight edge is desirable. Similarly, an uppermost panel (i.e., a finishing panel) may have a substantially straight top edge, if desired.

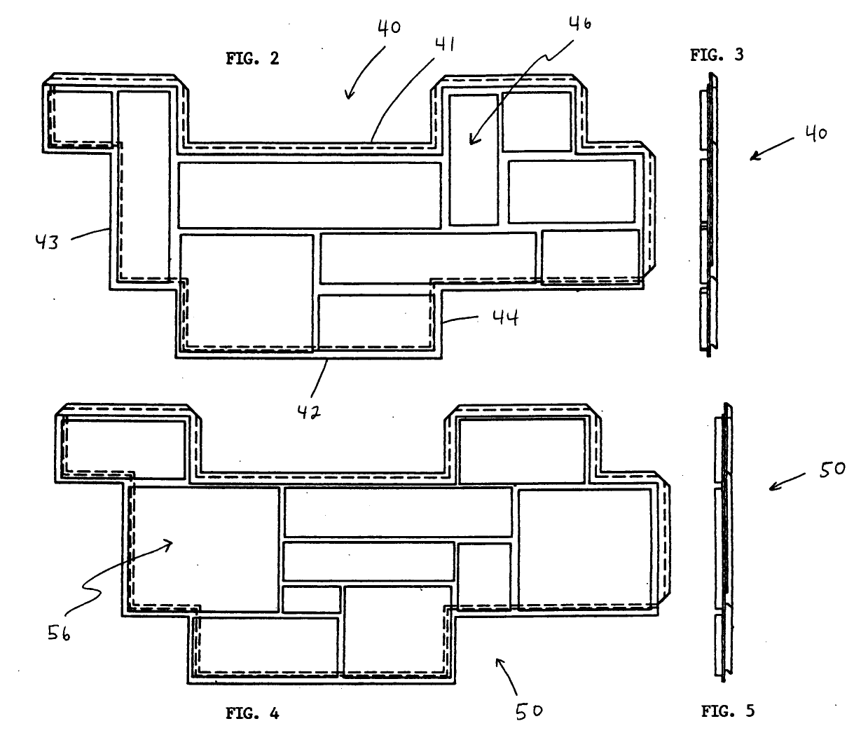

FIGS. 2 through 5 show examples of field panels. More particularly, FIGS. 2 and 3 show field panel 40, and FIGS. 4 and 5 show field panel 50. At least one simulated stone along each edge of these panels juts out relative to the other simulated stones. For example, with reference to FIGS. 2 and 3, at least one simulated stone juts out relative to at least one other simulated stone along top edge 41, bottom edge 42, left edge 43, and right edge 44, respectively, of field panel 40. It should also be recognized that panel 40 and panel 50 may optionally have substantially the same overall shape. However, the configuration of the synthetic stones in each panel is different. In particular, simulated stone configuration 46 of panel 40 is different than simulated stone configuration 56 of panel 50. As a result, these exemplary panels may be used in the same panel assembly (e.g., a wall structure), and the different configurations of the synthetic stones may further help to obscure the joints between adjacent panels. In other words, the panels may be used to prevent a repetitive pattern of the synthetic stones, which may make it more difficult to distinguish the individual panels of the panel assembly. The other panels of the present invention may also incorporate this feature to prevent a repetitive pattern of the synthetic stones.

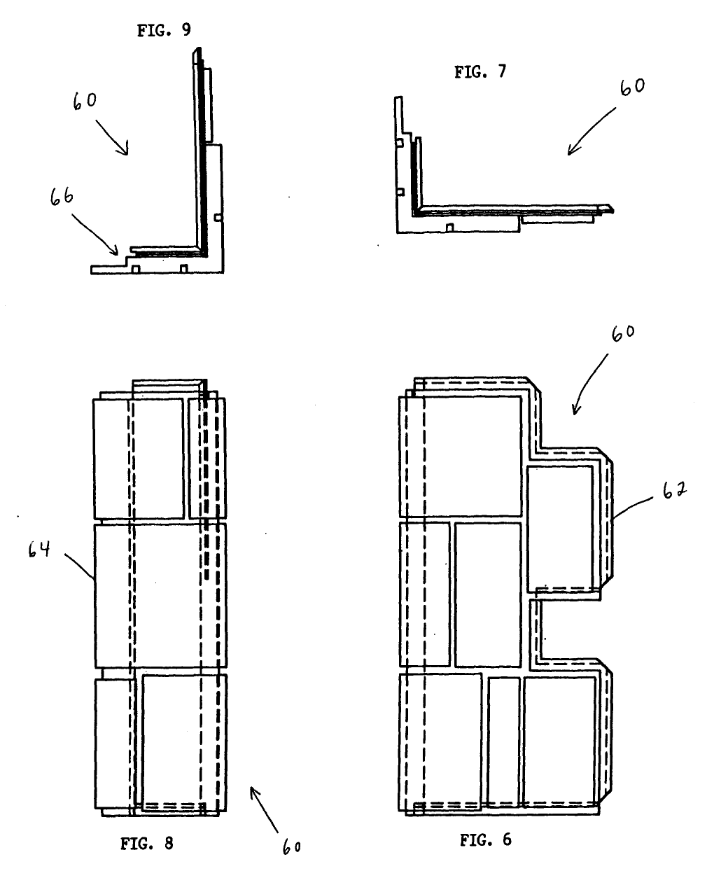

FIGS. 6 through 9 show an example of a corner panel 60 of the present invention. In this example, at least one simulated stone may jut out relative to at least one other simulated stone along edge 62 of corner panel 60 such as shown in FIG. 6. Furthermore, such as shown in FIG. 8, the synthetic stones along edge 64 of panel 60 may optionally be evenly aligned. Edge 64 may include a pocket or recessed portion 66 for receiving, engaging, or otherwise overlapping the edge of another panel or panels. Nevertheless, it should be recognized that at least one synthetic stone along such an edge may jut out, if desired, in other embodiments of the present invention.

FIGS. 10 through 16 show exemplary installations using panels and components of the present invention. In an exemplary installation, adjacent panels may be connected together in any suitable manner. For example, such as described above, a pocket or recessed portion of one panel may receive, engage, or otherwise overlap an edge of another panel or panels. For instance, an edge or flange of one panel may be inserted into a pocket or recessed portion of another panel to interlock the panels together. Optionally, fasteners may be used to connect adjacent panels together. Examples of fasteners include, but are not limited to, mechanical fasteners (e.g., screws, nails, pins, clamps, etc.), fabric fasteners (e.g., VELCRO and other hook and loop fastening materials), adhesives, glues, epoxies, polymers, tapes (e.g., pressure sensitive adhesive tapes), and other similar or suitable attachment materials.

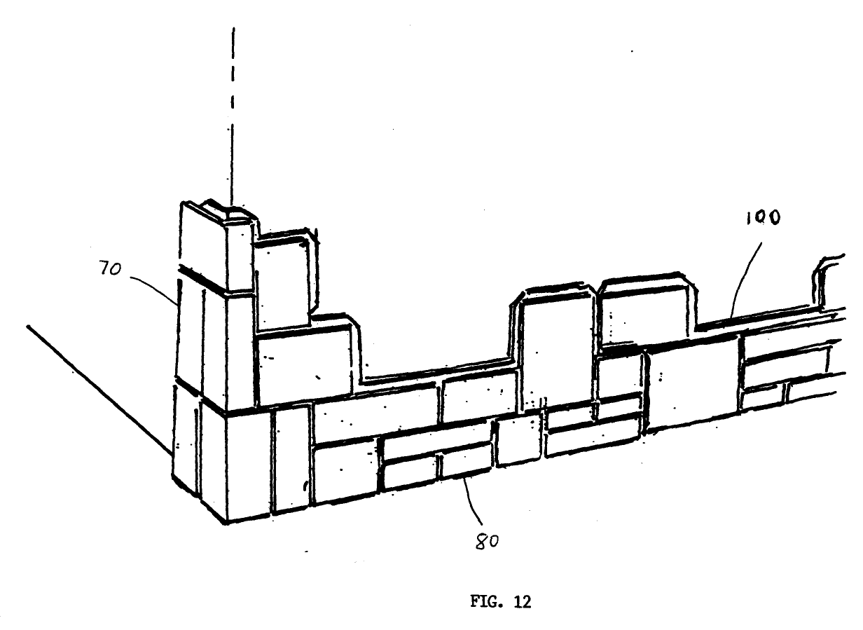

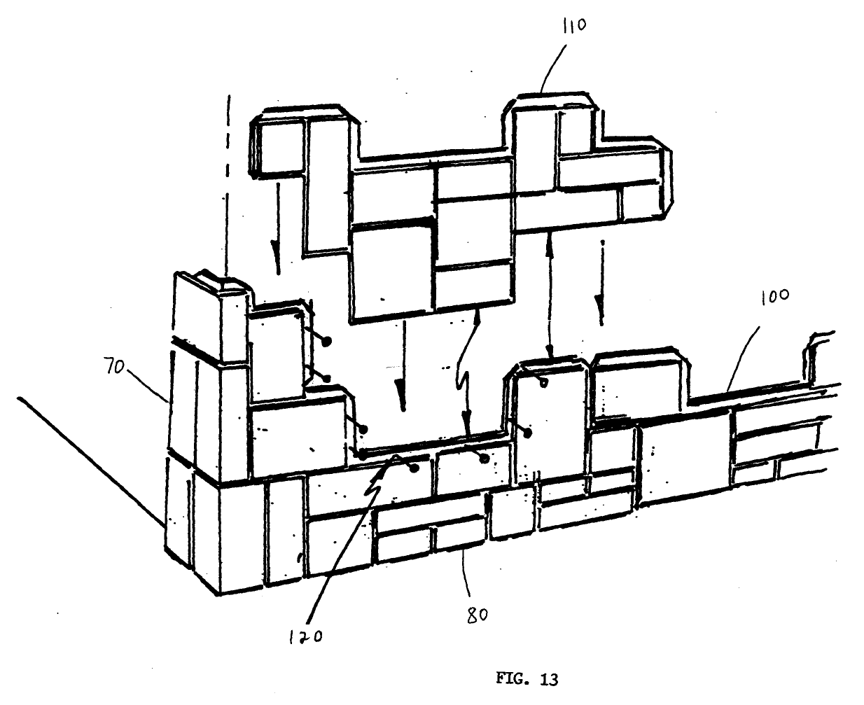

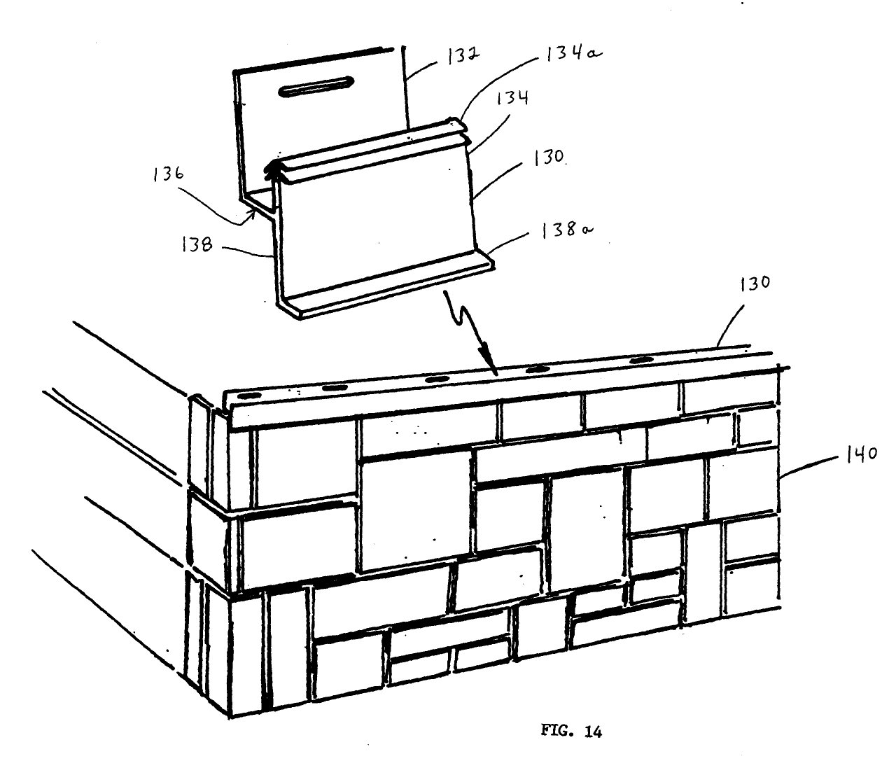

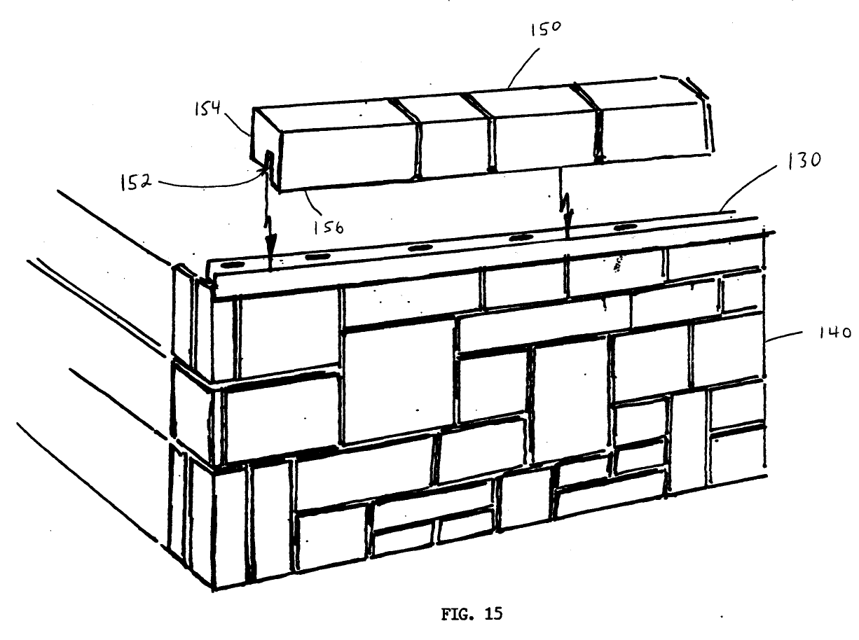

In one example, FIG. 10 shows an exemplary embodiment of a corner panel 70 connected to an exemplary embodiment of a starter panel 80. In particular, a jutting simulated stone 82 of starter panel 80 extends into a recessed portion 72 of an edge of corner panel 70, which may assist in making it more difficult to see or notice a joint between the panels. Such as shown in FIG. 11, another corner panel 90 may be stacked on corner panel 70 in this exemplary embodiment. FIG. 12 shows another exemplary embodiment of starter panel 100 connected to starter panel 80. It should be noted that starter panel 100 has a different simulated stone configuration than starter panel 80 in this example. FIG. 13 shows an exemplary embodiment of a field panel 110 stacked on corner panel 70, starter panel 80, and starter panel 100. Such as in this example, stacking a panel on more than one other panel may also assist in making it more difficult to see or notice a joint between the panels. Furthermore, FIG. 13 shows an example of how fasteners 120 may be inserted through fastener surfaces of each of the underlying panels to facilitate securing the underlying panels to a base structure.

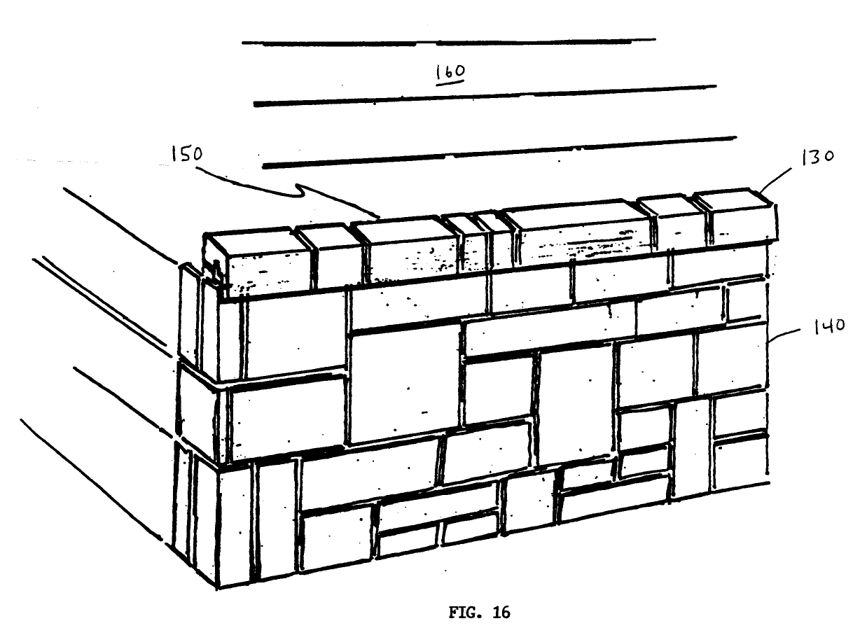

FIG. 14 shows an example of a cap cup 130 that may be used along an edge of a panel assembly or wall structure 140. A cap cup may be made in any suitable manner including, but not limited to, extrusion, injection molding, compression molding, and any other suitable type of molding. As shown in FIG. 14, cap cup 130 may include a flange 132, which may optionally include an aperture for receiving a fastener that may be used to secure cap cup 130 to a base structure. In this exemplary embodiment, flange 132 may be substantially L-shaped. A male connector portion 134 may extend upwardly from a proximal portion of flange 132 such that a channel 136 may be formed between flange 132 and male connector portion 134. Optionally, male connector portion 134 may include a tip 134a comprised of at least one flange. For instance, such as shown in this example, tip 134a may be shaped like an arrow. Optionally, tip 134a may be comprised of a flexible plastic material to facilitate connection with another component. Furthermore, a bottom portion 138 may optionally extend downwardly from a proximal portion of flange 132. Bottom portion 138 may be substantially L-shaped such that a flange 138a may assist with supporting another component.

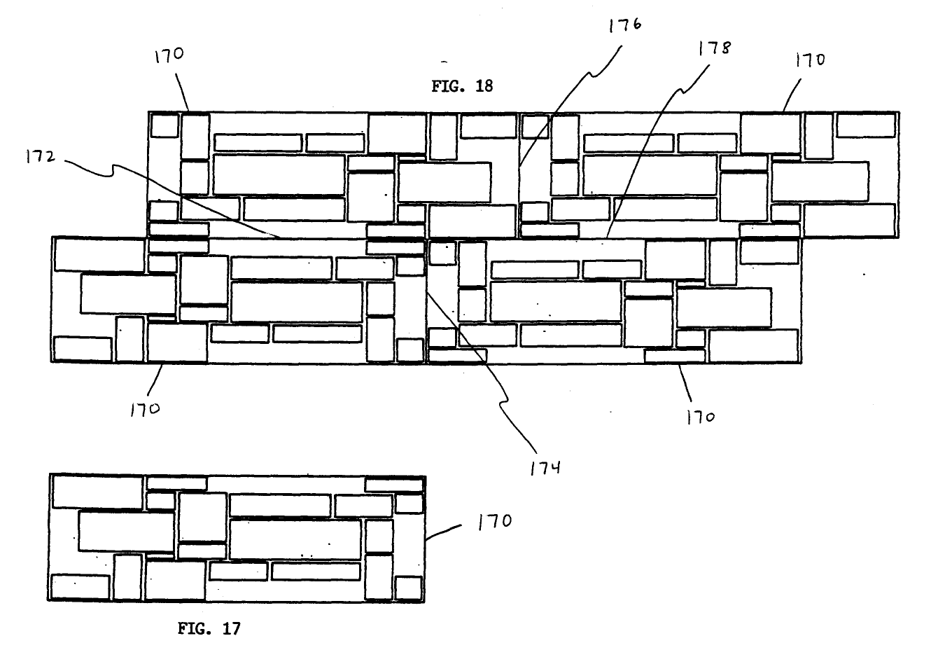

FIG. 15 shows an example of how cap cup 130 may facilitate connection with another component. In particular, such as shown in FIG. 15, a cap trim block 150 may be provided on or positioned over cap cup 130. In an exemplary embodiment, a cap trim block may be made in a similar manner as an exemplary embodiment of a panel of the present invention. Referring to FIG. 15, cap trim block 150 may include a female connector portion 152 that is adapted to receive male connector portion 134 of cap cup 130. Optionally, female connector portion 152 may include at least one inner ridge adapted to engage tip 134a of male connector portion 134 such that an interlocking connection may be formed. When female connector portion 152 of cap trim block 150 receives male connector portion 134 of cap cup 130, a rear portion 154 of cap trim block 150 may be received in channel 136 of cap cup 130, and a front portion 156 of cap trim block 150 may extend over bottom portion 138 of cap cup 130 such that it may optionally rest on flange 138a. Thus, cap trim block 150 may be used to provide a desired edge to wall structure 140 such as shown in FIG. 16. In addition, it may also provide a desired transition to another building material, such as siding 160 as shown in FIG. 16. In other embodiments, a cap trim block may be used to provide a desired transition to other building materials such as stucco, bricks, concrete, wood planking, or any other building or construction materials.

It should be also recognized that FIGS. 14 and 15 merely show one example of a cap cup and a cap trim block, respectively. Other configurations of a cap cup and a cap trim block are possible such that a cap trim block may be provided on a cap cup. For example, a cap cup may include a female connector portion that is adapted to receive a male connector portion of a cap trim block.

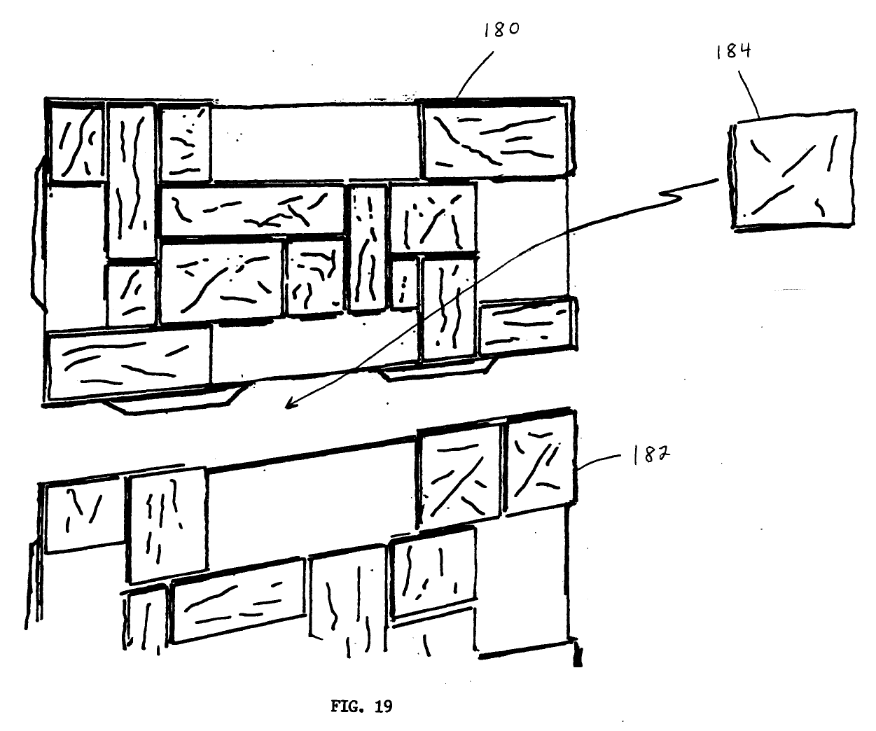

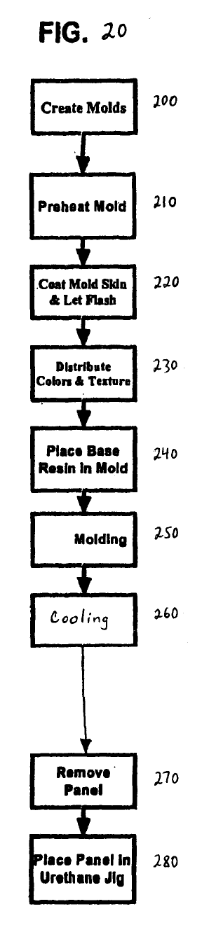

FIG. 17 shows another example of a panel of the present invention. Again, at least one stone juts out relative to the other stone(s) along at least one edge of panel 170. However, such as shown in FIG. 17, panel 170 may still have at least one substantially straight edge even though the synthetic stones are not evenly aligned. In particular, FIG. 17 shows an example in which each edge of the panel is substantially straight even though the synthetic stones are uneven along the edges. As a result, this type of configuration enables the use of square panels, rectangular panels, and panels of other shapes having straight edges. FIG. 18 shows an exemplary installation of panels 170 stacked together. Such as shown in FIG. 18, it should be noted that panels 170 may be rotated relative to each other to make it more difficult to distinguish the joints between the panels. Furthermore, such as shown in FIG. 18, one row of panels 170 may be offset relative to another row of panels 170 to make it more difficult to distinguish the joints between the panels. Optionally, simulated filler stones may be used to obscure or hide joint 172, joint 174, joint 176, and joint 178 between adjacent panels 170. In other words, simulated filler stones may be used to fill in the gaps between the simulated stones after panels 170 have been connected together.

FIG. 19 is another example of panels having at least one substantially straight edge even though the synthetic stones are not evenly aligned. In this example, after panel 180 and panel 182 have been connected together, at least one filler stone 184 may be used to fill in the gap between the stones of the adjacent panels. For example, such as shown in FIG. 19, filler stone 184 may cover the joint between panel 180 and panel 182, thereby obscuring the joint between the panels. A filler stone may be secured to the underlying panels using any suitable techniques and materials. For instance, examples of fasteners that may be used to secure a filler stone to an underlying panel include, but are not limited to, mechanical fasteners (e.g., screws, nails, pins, clamps, etc.), fabric fasteners (e.g., VELCRO and other hook and loop fastening materials), adhesives, glues, epoxies, polymers, tapes (e.g., pressure sensitive adhesive tapes), and other similar or suitable attachment materials.

The panels may be manufactured using any suitable process for providing the desired appearance. For example, U.S. Pat. No. 6,726,864 and U.S. Patent Application Publication No. US 2005/0087908 describe simulated substrate texture processes that may be useful for manufacturing exemplary panels of the present invention. U.S. Pat. No. 6,726,864 and U.S. Patent Application Publication No. US 2005/0087908 also describe materials that may be useful for simulating the appearance of certain building or construction products. Accordingly, the entirety of U.S. Pat. No. 6,726,864 and U.S. Patent Application Publication No. US 2005/0087908 are also incorporated by reference.

For instance, in one exemplary method of manufacturing a panel, a mold may be used that is configured to form a panel that is adapted to simulate the appearance of stones or another desired building or construction material. In addition, materials may be selected that are adapted to simulate the colors and textures of stones or another building or construction material. An adhesive, the coloring and texturing materials, and a base resin charge may be then be provided in the mold such that the adhesive retains the coloring and texturing materials. Molding may then be performed at a temperature sufficient to accomplish melting fusion and thereby form the panel. One example of a molding process is rotational molding. Examples of other suitable molding processes for manufacturing exemplary panels include, but are not limited to, blow molding, vacuum molding, compression casting, compression molding, and injection molding.

Examples of composite mixtures suitable for manufacturing some exemplary embodiments of panels (preferably via molding processes contemplated hereunder) may comprise some or all the following components:

| No. | Component | % by Volume |
|---|---|---|
| 1 | Tires | 5-40 |
| 2 | Dried Solids | 3-3.5 |
| 3 | Polymer | 60-80 |
| 4 | Glue | 3-10 |
| 5 | Sand | 10-22 |
| 6 | Cement | 5-11 |
| 7 | Coloring | 5-12 |
| 8 | Color Hardener | 4-14 |

As will be appreciated by those skilled in the art, selection of a suitable molding powder or resin is a step of a successful molding operation. Any suitable plastic may be used to manufacture an exemplary panel of the present invention. For example, it has been found that suitable UV-stabilized polyethylene raw material resins that are commercially available from several manufacturers, with a melt index in the range 2.0-6.5, are particularly applicable to some exemplary embodiments of the present invention. Some resins having an acceptable combination of density per ASTM D-1505 and melt index per ASTM D-1238 (condition 2.16, 190) are illustrated in Table 1. It will be appreciated that these formulations—in conjunction with the manufacturing techniques taught hereunder—may be used to produce exemplary panels having superior mechanical properties, e.g., higher stiffness, excellent low temperature impact strength, and environmental stress crack resistance.

TABLE 1
Polyethylene By Ascending Melt Index

| | 1 | 2 | 3 | 4 | 5 | 6 |
|---|---|---|---|---|---|---|
| Density | .941 | .938 | .938 | .941 | .935 | .936 |
| Melt Index | 2.0 | 2.6 | 3.5 | 4.0 | 5.9 | 6.5 |
| Flexural Modulus | 130,000 | 95,000 | 102,000 | 120,000 | 87,000 | 80,700 |

Polyethylene raw materials contemplated by some exemplary embodiments of the present invention may be readily obtained from suppliers worldwide. Suppliers in the United States include Southern Polymer, Inc. of Atlanta, Ga.; Mobil Chemical of Edison, N.J.; Millennium Petrochemicals Inc. of Cincinnati, Ohio; H. Muehlstein & Company, Inc. of Houston, Tex.; Chroma Corporation of McHenry, Ill.; A. Schulman, Inc. of Akron, Ohio; and Formosa Plastics. For instance, an exemplary Southern Polymer LLDPE resin corresponding to properties shown in column 4 of Table 1, includes a tensile strength of 2,700 psi per ASTM D-638 (2″ per minute, Type IV specimen, @0.125″ thickness), heat distortion temperature of 53° C. @ 66 psi and 40° C. @ 264 psi per ASTM D-648, low temperature impact of 50 ft. lbs. for a ⅛″ specimen and 190 ft. lbs. for a ¼″ specimen per ARM Low Impact Resistance.

As another example, Millennium Petrochemicals sells LLDPE resin GA-635-661 corresponding to properties shown in column 6 of Table 1, which includes a tensile strength of 2,500 psi per ASTM D-638, heat distortion temperature of 50° C. @ 66 psi and 35° C. @ 264 psi per ASTM D-648, low temperature impact of 45 ft. lbs. for a ⅛″ specimen and 200 ft. lbs. for a ¼″ specimen per ARM Low Impact Resistance, and ESCR Condition A, F50 of greater than 1,000 hrs. per ASTM D-1693 @ 100% Igepal and 92 hrs. @ 10% Igepal. Similarly, Mobil Chemical sells MRA-015 corresponding to properties shown in column 5 of Table 1, which includes a tensile strength of 2,650 psi, heat distortion temperature of 56° C. @ 66 psi and 39° C. @ 264 psi, low temperature impact of 58 ft. lbs. for a ⅛″ specimen and 180 ft. lbs. for a ¼″ specimen, and ESCR Condition A, F50 of more than 1,000 hrs. @ 100% Igepal. Similarly, Nova Chemicals sells TR-0338-U/UG corresponding to properties shown in column 3 of Table 1, which includes a tensile strength of 3,000 psi, heat distortion temperature of 50° C. @ 66 psi, low temperature impact of 60 ft. lbs. for a ⅛″ specimen, and ESCR Condition A, F50 of more than 1,000 hrs. @ 100% Igepal.

As yet another example is Formosa Plastics' Formolene L63935U having Melt Index of 3.5 and density of 0.939, along with flexural modulus of 110,000 psi, a tensile strength of 3,300 psi at yield, heat defection temperature of 54° C. @ 66 psi, low temperature impact of 60 ft. lbs. for a ⅛″ specimen, and ESCR Condition A, F50 of greater than 1,000 hrs. @ 100% Igepal and 60 hrs. @ 10% Igepal.

Another component of the combinations of materials taught by an exemplary embodiment of the present invention may be an adhesive adapted to accomplish the purposes herein described in detail. For example, XP-10-79° C. pressure sensitive adhesive of Chemical Technology Inc. (Detroit, Mich.) is a water base adhesive with a styrene butadiene adhesive base designed to bond various foam substrates, such as polyethylene and polystyrene. Representative properties include a viscosity of 5000-7000 cps Brookfield RVT Spindle #3 @ 77° F.; pH of 7.5-9.5; weight per gallon of 8.3 lb; no flash point; color blue; 50-54% solids; 20 minutes dry time; no freeze/thaw cycle (may be frozen). Another example of a suitable adhesive is a Henkel Adhesives (Lewisville, Tex.) polyvinyl resin emulsion 52-3069 having a viscosity of 3750 cps Brookfield RVT @ 76° F.; pH 4.5; weight per gallon of 9.0 lb; 55% solids; 212 boiling point ° F.; specific gravity of 1.1; vapor pressure the same as water @ 20° C.; solubility in water is dispersible when wet; white fluid appearance; polyvinyl odor; no flash point. Nevertheless, it should be recognized that any other suitable adhesive may be used for an exemplary method of the present invention.

It will be appreciated that another component of an exemplary embodiment of the present invention is pigment colors and texturing materials that may, for example, be selected from a broad group of organic materials, inorganic materials, mineral oxides, cement, graded silica aggregates, and special conditioning admixtures. For example, one suitable pigment color component is Bomanite Color Hardener, among others, which is a dry shake material designed for coloring and hardening concrete flatwork. It is comprised of a blend of mineral oxide pigments, cement, and graded silica aggregates. It has also been found that special conditioning admixtures may be included in exemplary formulations to improve workability.

Bomanite Color Hardener has been found to be useful either in its regular grade or in its heavy duty grade. As will be appreciated by those skilled in the art, the regular grade is commonly intended for applications such as residential driveways, patios, pool decks, entryways, walkways, showroom floors, lobbies, and medians. On the other hand, the heavy duty grade, formulated with specially graded Emery, i.e., aluminum oxide for increasing wear resistance, is commonly intended for heavy-traffic applications such as vehicular entrances, theme parks, plazas, crosswalks, street sections, and highly-trafficked sidewalks. As will be understood by those conversant in the art, color hardeners such as Bomanite Color Hardener may afford a variety and intensity of colors such that many hues—ranging from soft pastels to vivid blues and purples—may be obtained with improved imprinting, increased durability, and increased resistance to wearing and fading.

As will be readily appreciated by those skilled in the art, another component material taught by an exemplary embodiment of the present invention is foam, which may include, but is not limited to, conventional ½ pound density packing urethane foam. For such exemplary structures and panels as simulated stone and masonry and brick wall panels, this urethane foam may impart not only excellent sound absorption qualities, but also structural stability. It should be evident to those skilled in the art that exemplary simulated stone, masonry, and brick texture wall panels such as contemplated by the present invention may accurately replicate the look-and-feel of stone, masonry, and brick, respectively, and simultaneously may also replicate some of the physical properties of stone, masonry, and brick.

Molding processes including, but not limited to, rotational molding and compression casting have been found to be advantageous for manufacturing some exemplary simulated stone, masonry and brick structures and panels of the present invention.

Some exemplary simulated stone, masonry, and brick panels contemplated by the present invention may be formed via molding effectuated at temperatures between 400-695° F. In particular, to achieve the stone, masonry and brick panels and structures contemplated by some exemplary embodiments of the present invention, it may be useful to effectuate the multi-step manufacturing procedure depicted in the block diagram in FIG. 20. In step 210 of an exemplary method, a specially-designed preferably cast aluminum mold (manufactured in step 200) may be preheated in a molding-oven to an outside mold temperature in the range 350-750° F., and preferably to an outside mold temperature in the range 500-650° F., and more preferably to an outside mold temperature in the range 550-625° F.

It has been found that, generally, the best results contemplated under one exemplary embodiment of the present invention may be obtained when the outside mold temperature is about 575° F. As will be understood by those skilled in the art, the temperature of the outside mold may be sufficiently elevated in the range 250-400° F. to enable flashing of the adhesive (e.g., a modified latex adhesive). It should be understood that the term “flashing” is meant to correspond to substantially removing all of the water from a water-based adhesive so that only solids remain; this, of course, may avoid the adverse formation of steam in the mold as heat is applied thereto in an exemplary method of the present invention.

After the mold is preheated as hereinbefore described, in step 220, the mold may be opened to provide access to its face for placement of adhesives, color components, and texture components. More particularly, in an exemplary method with the mold now opened, the face of the mold may be lightly coated with adhesive and allowed to set until the glue flashes or becomes tacky to touch. One example of a glue found to be effective for the purposes of one exemplary embodiment of the present invention is Henkel MM 8-15-1. For example, it has been found to be particularly effective to spray latex adhesive using an airless spray means in such quantity to assure the in situ retention of coloring pigments and texturing materials. Ergo, it should be clear that a preheating step of an exemplary method may be incorporated in an exemplary manufacturing process to enable a modified latex adhesive to be flashed-off the mold surface. That is, an exemplary preheating step may cause the water portion of the adhesive to evaporate, thereby leaving a solid residue for retaining coloring pigments and texturing materials in place while a resin is melting and being formed into a wall panel, for example, such as contemplated by an exemplary embodiment of the present invention.

In the next step depicted in the example of FIG. 20 as step 230, a panoply of colors corresponding to the stones and/or masonry and/or bricks and/or other desired substrates being simulated may be selected. Color pigments and texturing components may be applied to the face of the mold wherein these components may become embedded with or integrated into the adhesive. In one exemplary method of the present invention, it will be understood that a well-known dry shake method or the like may then be used on the basis that the color pigments and texturing components may optionally be in powder form, preferably with mesh sizes of no more than the range 10-60.

Referring to one exemplary simulated stone and/or masonry and/or brick textured wall panel as an illustrative panel that may be manufactured by the techniques taught by an exemplary method of the present invention, it has been found that providing color pigments and texturing components in a range of about 5-20% of the total weight of a base resin may provide desirable results for some exemplary embodiments of simulated stone, masonry, and brick panels.

Again, using an exemplary simulated stone and/or masonry and/or brick wall panel for illustrative purposes, it will become evident that an example of a completely formulated and manufactured wall panel may comprise base resin, color pigments and texturing components, and unflashed adhesives. Thus, to produce such an exemplary wall panel, in step 240 of this exemplary method, the mold may be loaded with a base resin charge (e.g., polyethylene) optionally in conjunction with other polymers and oxide pigments. As previously described with regard to step 230, color hardener, such as a Coloration Systems hardener, consisting of graded silica aggregates, cement, and mineral oxide pigments, may have been previously applied to the face of the mold using a dry shake method in one exemplary method of the present invention.

Next, in step 250, the mold may be closed and prepared for a molding cycle (e.g., rotational molding or compression casting). While, of course, any molding apparatus may suffice, it may be preferable to effectuate the molding process (step 250) using a casting oven, a rotational molding apparatus, or any other similar apparatus. As will become evident to those skilled in the art, the oven temperature in an exemplary method may be about 500° F.-650° F., preferably for sufficient time for the resin to become stable.

In step 260, as should be clear to those skilled in the art, the molded material may then subjected to a cooling cycle in the mold, in a conventional cooling jig, or in other suitable cooling system wherein the uniform shape thereof may be sustained. For instance, in one exemplary method of cooling, the molded product may be subjected to blown air, water (e.g., spray mists), or alternating cycles of blown air and water. Next, in one exemplary method, the cooled product may be removed from the mold in step 270 and placed in a reinforcing form in step 280. In step 280, a foam backer may optionally be applied to the cooled panel.

It is an advantage and feature of one exemplary embodiment of the present invention that panels (e.g., siding panels, wall panels, fence panels, barrier panels, etc.) may be produced from the materials hereinbefore described according to the exemplary molding techniques of the present invention such that the panels are not only surprisingly lightweight, but also are readily stacked and layered together. This novel stacked and layered structure may enable simulated panels or the like to be used as panels for homes, buildings, walls, fences, or the like. It is also an advantage and feature of an exemplary embodiment of the present invention that structures and panels produced as herein elucidated may be surprisingly lightweight and may be manufactured in a wide range of colors.

It will be appreciated that exemplary embodiments of the present invention may be constructed from not only polyethylene materials, but also from a plethora of other commercially available suitable plastic materials. It should also be clear that an advantage of an exemplary embodiment of the present invention may be its unique ability to inherently obtain an integrated finish, and, preferably, to obtain a totally integrated finish. Furthermore, it has been discovered that the efficacy of some exemplary embodiments of the present invention may be attributable to using synergistic formulations of special adhesives and to preparing suitable molds for receiving other synergistic combinations of virgin and recycled materials such as described herein.

It has further been discovered that, indeed, a broad range of plastics may be accommodated by the exemplary teachings herein. For instance, such components as rubber, tire rubber, and even chrome rubber may be advantageously used in some exemplary embodiments as described herein. As another example of the breadth of the applicability of exemplary embodiments of the present invention, both linear low-density polyethylene and very low-density linear polyethylene may be effectively used in some exemplary embodiments of the present invention.

As will be appreciated by those skilled in the art, manufacturing procedures of some exemplary embodiments of the present invention may incorporate compression casting, blow molding, rotational molding, injection molding, compression molding, and/or vacuum molding techniques. It has been discovered that vacuforming techniques may also be invoked to produce exemplary siding panel embodiments contemplated hereunder. For example, in some of these approaches, the specially formulated materials taught herein may be injected or drawn into a prepared mold, respectively, instead of or as a supplement to being loaded into a pre-charged mold. The exemplary simulated stone, masonry and brick textured panel embodiments that are thus produced may provide the unique characteristics and properties herein elucidated in detail.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to affect the described invention. Many of those variations and modifications will provide the same result and fall within the spirit of the claimed invention. It is the intention, therefore, to limit the invention only as indicated by the scope of the claims.

What is claimed is:

1. A method of manufacturing a simulated stone panel, said method comprising the steps of:
providing a mold configured to form a panel that is adapted to simulate the appearance of stones;
selecting materials adapted to simulate stone colors and textures;
providing an adhesive, said coloring and texturing materials, and a base resin charge in said mold such that said adhesive retains said coloring and texturing materials; and
molding at a temperature sufficient to accomplish melting fusion and form said simulated stone panel;
wherein at least one simulated stone juts out relative to at least one other simulated stone along an edge of said simulated stone panel.

2. The method of claim 1 further comprising the step of preheating said mold.

3. The method recited claim 1 wherein said adhesive is provided in said mold prior to said coloring and texturing materials and said base resin charge.

4. The method of claim 1 wherein the step of providing said adhesive in said mold comprises coating a face of said mold with said adhesive.

5. The method of claim 1 wherein said adhesive is a latex glue material.

6. The method of claim 1 further comprising the step of allowing said adhesive to set in said mold until said adhesive flashes off substantially all water contained therein such that said adhesive is suitable for retaining said coloring and texturing materials.

7. The method of claim 1 wherein said coloring and texturing materials are selected from the group consisting of tires, dried solids, sand, cement, organic materials, inorganic materials, pigments, mineral oxides, graded silica aggregates, color hardeners, and conditioning admixtures comprised of a combination of at least some of the aforementioned materials.

8. The method of claim 1 wherein the ratio of the weight of said coloring and texturing materials to the weight of said base resin charge is between about 5% and about 20%.

9. The method of claim 1 wherein said base resin charge comprises polyethylene.

10. The method of claim 1 wherein said molding of said base resin charge comprises rotational molding.

11. The method of claim 1 wherein said molding of said base resin charge comprises a molding process selected from the group consisting of blow molding, vacuum molding, compression casting, compression molding, injection molding, and vacuforming.

12. The method of claim 1 further comprising the step of cooling said simulated stone panel.

13. The method of claim 1 further comprising a foam injection step adapted to provide shape retention and sound deadening properties to said simulated stone panel.

14. The method of claim 13 wherein said foam injection step comprises the addition of a foam backing to said simulated stone panel.

15. The method of claim 1 wherein said simulated stone panel is adapted to be connected with at least one similar simulated stone panel to form a wall, a fence, or a barrier.

16. A method of providing an assembly of simulated stone panels, said method comprising the steps of:
manufacturing a first simulated stone panel and a second simulated stone panel, said manufacturing of each of said first simulated stone panel and said second simulated stone panel comprising the steps of:
(a) providing a mold configured to form a panel that is adapted to simulate the appearance of stones;
(b) selecting materials adapted to simulate stone colors and textures;
(c) providing an adhesive, said coloring and texturing materials, and a base resin charge in said mold such that said adhesive retains said coloring and texturing materials; and
(d) molding at a temperature sufficient to accomplish melting fusion and form a simulated stone panel; and
connecting said first simulated stone panel to said second simulated stone panel;
wherein said first simulated stone panel and said second simulated stone panel have substantially the same overall shape; and
wherein first simulated stone panel has a different configuration of stones than said second simulated stone panel.

17. The method of claim 16 wherein said manufacturing step further comprises the step of allowing said adhesive to set in said mold until said adhesive flashes off substantially all water contained therein such that said adhesive is suitable for retaining said coloring and texturing materials.

18. The method of claim 16 wherein said molding of said base resin charge comprises rotational molding.

19. A method of providing an assembly of simulated stone panels, said method comprising the steps of:
manufacturing a plurality of simulated stone panels, said manufacturing of each of said panels comprising the steps of:
(a) providing a mold configured to form a panel that is adapted to simulate the appearance of stones;
(b) selecting materials adapted to simulate stone colors and textures;
(c) providing an adhesive, said coloring and texturing materials, and a base resin charge in said mold such that said adhesive retains said coloring and texturing materials; and
(d) molding at a temperature sufficient to accomplish melting fusion and form a simulated stone panel;
manufacturing a simulated stone cap in similar manner as said simulated stone panels;
connecting said simulated stone panels together;
providing a trim component along an edge of said connected simulated stone panels; and
providing said simulated stone cap on said trim component.

20. The method of claim 19 wherein each of said molding steps comprises rotational molding.
